(19) United States
(12) Patent Application Publication
(10) Pub. No.: US 2021/0360724 A1
(43) Pub. Date: Nov. 18, 2021

(54) COMMUNICATION APPARATUS, COMMUNICATION SYSTEM, COMMUNICATION METHOD, AND NON-TRANSITORY COMPUTER READABLE MEDIUM

(71) Applicant: NEC Corporation, Tokyo (JP)

(72) Inventor: Tomoaki SATO, Tokyo (JP)

(73) Assignee: NEC Corporation, Tokyo (JP)

(21) Appl. No.: 17/316,924

(22) Filed: May 11, 2021

(30) Foreign Application Priority Data
May 13, 2020 (JP) 2020-084333

(51) Int. Cl. H04W 76/18; H04W 72/08; H04W 28/02

(52) U.S. Cl. CPC H04W 76/18; H04W 28/0236; H04W 28/0278; H04W 72/08

(57) ABSTRACT

The present disclosure provides a communication apparatus, a communication system, a communication method, and a non-transitory computer readable medium capable of easily detecting degradation of transmission quality while keeping costs low. A communication apparatus 10 includes: a statistical information calculation unit 121 that subtracts total output statistical information, which is a total amount of output data output through communication ports 111 and 112 within a predetermined period, from total input statistical information, which is a total amount of input data input through the communication ports 111 and 112 within the predetermined period; and a management information communication unit 122 that transmits failure information indicating that degradation of transmission quality has occurred to a network management apparatus 20 when an absolute value of a result of the calculation performed by the statistical information calculation unit 121 is equal to or greater than a predetermined threshold.

### INCORPORATION BY REFERENCE

This application is based upon and claims the benefit of priority from Japanese patent application No. 2020-084333, filed on May 13, 2020, the disclosure of which is incorporated herein in its entirety by reference.

### TECHNICAL FIELD

The present disclosure relates to a communication apparatus, a communication system, a communication method, and a non-transitory computer readable medium storing a communication program.

### BACKGROUND ART

In radio transmission, the quality of radio transmission is degraded due to the influence of weather and the like and hence the communication band is reduced. At this time, whether or not a main signal is discarded varies in accordance with the amount of input of user traffic. In order to achieve good radio communication, it is desirable to detect whether unintentional discarding of a main signal has occurred.

Japanese Unexamined Patent Application Publication No. 2005-072723 discloses that a communication apparatus (hereinafter referred to as a “radio transmission apparatus”) that performs radio transmission transmits statistical information of all traffic to a network management system (NMS), and the NMS performs analysis. In Japanese Unexamined Patent Application Publication No. 2005-072723, this configuration allows the NMS to detect that unintentional discarding of the main signal has occurred in the network.

In Japanese Unexamined Patent Application Publication No. 2014-165819, in a radio transmission apparatus, a section (hereinafter referred to as a “monitor section”) in which the occurrence of an error is to be monitored is determined in advance. Further, into a frame (hereinafter referred to as an “input frame”) that is input to the monitor section, input statistical information about the number of frames of the input frame is inserted, and this input statistical information is extracted from a frame (hereinafter referred to as an “output frame”) that is output from the monitor section. In this radio transmission apparatus, output statistical information about the number of frames of the output frame is also generated. Further, Japanese Unexamined Patent Application Publication No. 2014-165819 discloses that, in the radio transmission apparatus, the occurrence of an error in the monitor section is detected by comparing the input statistical information with the output statistical information.

However, in a radio transmission apparatus, a communication band for transmitting and receiving a main signal is generally used as a communication band for transmitting management data to an NMS. In Japanese Unexamined Patent Application Publication No. 2005-072723, a large amount of management data is transmitted to an NMS, which causes a problem that the management data narrows a communication band for transmitting and receiving a main signal. Further, as disclosed in Japanese Unexamined Patent Application Publication No. 2005-072723, in order to analyze and manage input/output statistical information based on management data of all of the radio transmission apparatuses in the NMS, an NMS having a high computing power is required.

Further, in Japanese Unexamined Patent Application Publication No. 2014-165819, in the radio transmission apparatus, input statistical information is inserted into an input frame, output statistical information is generated from an output frame, and the input statistical information is compared with the output statistical information. Therefore, the input frame and the output frame are required to be linked by 1:1. Thus, when there are many output ports, it is necessary to manage input statistical information and output statistical information for all of the output ports. Consequently, a hardware configuration having a function of managing all of the output ports is required. This causes a problem that the radio transmission apparatus becomes expensive.

### SUMMARY

An object of the present disclosure is to provide a communication apparatus, a communication system, a communication method, and a non-transitory computer readable medium that are capable of easily detecting degradation of transmission quality while keeping costs low.

A communication apparatus according to a first example aspect of the present disclosure includes: a statistical information calculation unit configured to subtract total output statistical information from total input statistical information, the total output statistical information being a total amount of output data that is output through a communication port within a predetermined period, the total input statistical information being a total amount of input data that is input through the communication port within the predetermined period; and a management information communication unit configured to transmit failure information indicating that degradation of transmission quality has occurred to a network management apparatus when an absolute value of a result of the calculation performed by the statistical information calculation unit is equal to or greater than a predetermined threshold.

A communication system according to a second example aspect of the present disclosure includes: a plurality of communication apparatuses connected to one another through a network so that they can communicate with one another; and a network management apparatus configured to manage the communication performed by the plurality of communication apparatuses through the network, in which the communication apparatus includes: a statistical information calculation unit configured to subtract total output statistical information from total input statistical information, the total output statistical information being a total amount of output data that is output through a communication port within a predetermined period, the total input statistical information being a total amount of input data that is input through the communication port within the predetermined period; and a management information communication unit configured to transmit failure information indicating that degradation of transmission quality has occurred to the network management apparatus when an absolute value of a result of the calculation performed by the statistical information calculation unit is equal to or greater than a predetermined threshold.

A communication method according to a third example aspect of the present disclosure performed by a communication apparatus includes: subtracting total output statistical information from total input statistical information, the total output statistical information being a total amount of output data that is output through a communication port within a predetermined period, the total input statistical information being a total amount of input data that is input through the communication port within the predetermined period; and transmitting failure information indicating that degradation of transmission quality has occurred to a network management apparatus when an absolute value of a result of the calculation obtained by subtracting the total output statistical information from the total input statistical information is equal to or greater than a predetermined threshold.

A non-transitory computer readable medium according to a fourth example aspect of the present disclosure stores a communication program for causing a communication apparatus to: subtract total output statistical information from total input statistical information, the total output statistical information being a total amount of output data that is output through a communication port within a predetermined period, the total input statistical information being a total amount of input data that is input through the communication port within the predetermined period; and transmit failure information indicating that degradation of transmission quality has occurred to a network management apparatus when an absolute value of a result of the calculation obtained by subtracting the total output statistical information from the total input statistical information is equal to or greater than a predetermined threshold.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing an example of a communication apparatus according to an example embodiment of the present disclosure;

FIG. 2 is a block diagram showing an example of a communication system according to a first example embodiment of the present disclosure;

FIG. 3 is a diagram for explaining a case in which no failure has occurred in radio communication;

FIG. 4 is a table showing the relation between the number of input frames and the number of output frames of each communication apparatus in the case in which no failure has occurred in radio communication;

FIG. 5 is a diagram for explaining a case in which a failure has occurred in radio communication;

FIG. 6 is a table showing the relation between the number of input frames and the number of output frames of each communication apparatus in the case in which a failure has occurred in radio communication; and

FIG. 7 is a flowchart for explaining an example of a communication method according to the first example embodiment of the present disclosure.

### EXAMPLE EMBODIMENTS

An example embodiment of the present disclosure will be described below with reference to the drawings.

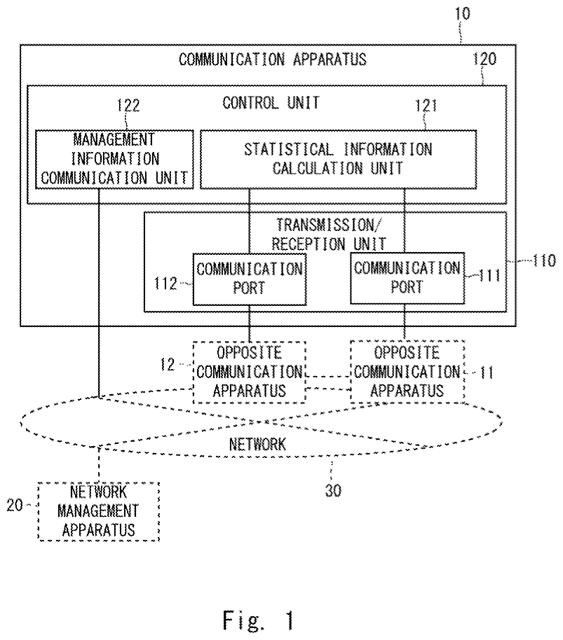

FIG. 1 is a block diagram showing an example of a communication apparatus 10 according to the example embodiment of the present disclosure. For example, the communication apparatus 10 according to the present disclosure is connected to other communication apparatuses (hereinafter referred to as “opposite communication apparatuses”) 11 and 12 through a network 30 so that they communicate with one another, and transmits and receives data to and from the opposite communication apparatuses 11 and 12. Further, the communication apparatus 10 is connected to a network management apparatus 20 through the network 30 so that they can communicate with each other. As shown in FIG. 1, the communication apparatus 10 includes a transmission/reception unit 110 and a control unit 120. Further, the transmission/reception unit 110 includes a plurality of communication ports 111 and 112. Note that the number of communication ports 111 and 112 which the transmission/reception unit 110 includes is not limited to the number of them shown in FIG. 1. The control unit 120 includes a statistical information calculation unit 121 and a management information communication unit 122.

The statistical information calculation unit 121 subtracts total output statistical information, which is the total amount of output data that is output through the communication ports 111 and 112 within a predetermined period, from total input statistical information, which is the total amount of input data that is input through the communication ports 111 and 112 within the predetermined period.

The management information communication unit 122 transmits failure information indicating that degradation of transmission quality has occurred to the network management apparatus 20 when the absolute value of a result of the calculation performed by the statistical information calculation unit 121 is equal to or greater than a predetermined threshold.

By the above-described communication apparatus 10 according to the example embodiment of the present disclosure, it is possible to detect degradation of transmission quality based on whether or not the difference between total input statistical information and total output statistical information within a predetermined period is equal to or greater than a predetermined threshold. That is, when unintentional discarding of a main signal has occurred due to degradation of transmission quality and hence the total amount of output data that is output through the communication ports 111 and 112 relative to the total amount of input data that is input through the communication ports 111 and 112 is reduced, it is possible to detect degradation of the transmission quality. Then, it is possible to send failure information indicating that degradation of the transmission quality has occurred to the network management apparatus 20.

Further, the communication apparatus 10 transmits only the failure information indicating that degradation of the transmission quality has occurred to the network management apparatus 20. This configuration eliminates the possibility of narrowing the communication band for transmitting and receiving the main signal.

Further, since input data and output data in all of the plurality of communication ports 111 and 112 are collectively managed, it is possible to make the hardware configuration of the communication apparatus 10 simple as compared with a case in which input data and output data are managed for each of the plurality of communication ports 111 and 112. Thus, it is possible to reduce the cost for the communication apparatus 10. Therefore, it is possible to easily detect degradation of transmission quality while keeping costs low.

### First Example Embodiment

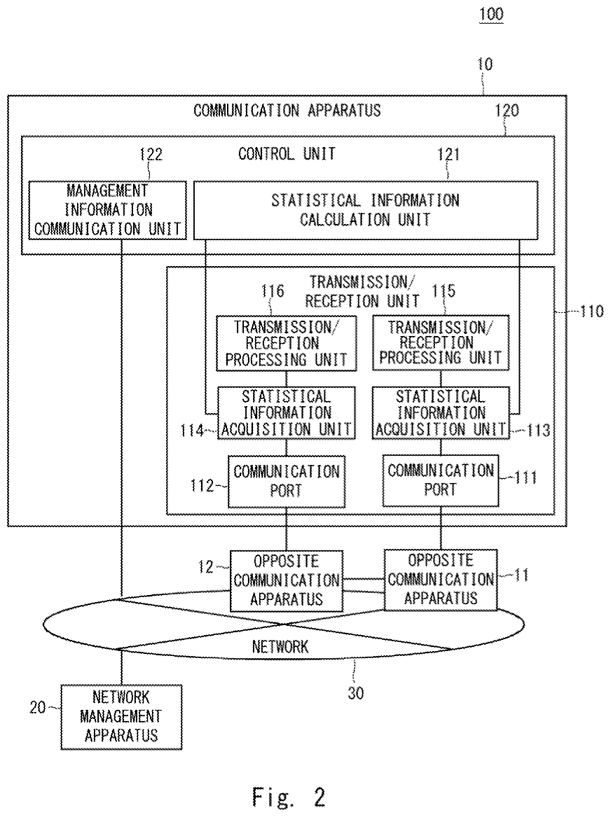

Next, the communication apparatus 10 and a communication system 100 according to a first example embodiment of the present disclosure will be described. FIG. 2 is a block diagram showing an example of the communication system 100 according to the first example embodiment of the present disclosure. As shown in FIG. 2, the communication system 100 includes the communication apparatus 10, the opposite communication apparatuses 11 and 12, the network management apparatus 20, and the network 30. For example, the communication apparatus 10 is connected to the opposite communication apparatuses 11 and 12 through the network 30 so that they can communicate with one another, and transmits and receives data to and from the opposite communication apparatuses 11 and 12. Further, the communication apparatus 10 is connected to the network management apparatus 20 through the network 30 so that they can communicate with each other. Note that in the present disclosure, the network includes a Local Area Network (LAN), a Wide Area Network (WAN), and the Internet. Further, the network may also include a wireless connection and a wired connection.

Further, it is assumed that the opposite communication apparatuses 11 and 12 have the same configuration and function as those of the communication apparatus 10. Further, the communication apparatus 10 and the opposite communication apparatus 11, the communication apparatus 10 and the opposite communication apparatus 12, and the opposite communication apparatuses 11 and 12 are respectively connected to each other through the network 30 without other communication apparatuses being interposed therebetween.

As shown in FIG. 2, the communication apparatus 10 includes the transmission/reception unit 110 and the control unit 120. The transmission/reception unit 110 includes the plurality of communication ports 111 and 112, a plurality of statistical information acquisition units 113 and 114, and a plurality of transmission/reception processing units 115 and 116. Note that the number of communication ports 111 and 112, the number of statistical information acquisition units 113 and 114, and the number of transmission/reception processing units 115 and 116 which the transmission/reception unit 110 includes are not limited to the respective numbers of them shown in FIG. 2. The control unit 120 includes the statistical information calculation unit 121 and the management information communication unit 122.

The communication port 111 receives input data from the opposite communication apparatus 11 and transmits output data to the opposite communication apparatus 11. Similarly, the communication port 112 receives input data from the opposite communication apparatus 12 and transmits output data to the opposite communication apparatus 12.

The statistical information acquisition unit 113 acquires input statistical information, which is the amount of input data from the opposite communication apparatus 11, and output statistical information, which is the amount of output data to the opposite communication apparatus 11, within a predetermined period. Similarly, the statistical information acquisition unit 114 acquires input statistical information of input data from the opposite communication apparatus 12 and output statistical information of output data to the opposite communication apparatus 12 within a predetermined period. It should be noted that input statistical information and output statistical information, which are acquired by the statistical information acquisition units 113 and 114, are, for example, the number of frames of input data and the number of frames of output data, respectively. Further, input statistical information and output statistical information, which are acquired by the statistical information acquisition units 113 and 114, may be the number of bytes of input data and the number of bytes of output data, respectively. The statistical information acquisition units 113 and 114 input the acquired input statistical information and output statistical information to the statistical information calculation unit 121.

The transmission/reception processing unit 115 controls the communication port 111 and transmits and receives data to and from the opposite communication apparatus 11. Specifically, the transmission/reception processing unit 115 controls the communication port 111 so that it receives input data from the opposite communication apparatus 11 and transmits output data to the opposite communication apparatus 11. Similarly, the transmission/reception processing unit 116 controls the communication port 112 so that it receives input data from the opposite communication apparatus 12 and transmits output data to the opposite communication apparatus 12.

The statistical information calculation unit 121 acquires input statistical information and output statistical information within a predetermined period from the statistical information acquisition units 113 and 114. Further, the statistical information calculation unit 121 adds up the input statistical information acquired from the statistical information acquisition unit 113 and the input statistical information acquired from the statistical information acquisition unit 114, thereby calculating the total input statistical information. Similarly, the statistical information calculation unit 121 adds up the output statistical information acquired from the statistical information acquisition unit 113 and the output statistical information acquired from the statistical information acquisition unit 114, thereby calculating the total output statistical information. Then, the statistical information calculation unit 121 subtracts the total output statistical information, which is the total amount of output data that is output from the communication apparatus 10 through the communication ports 111 and 112 within a predetermined period, from the total input statistical information, which is the total amount of input data that is input to the communication apparatus 10 through the communication ports 111 and 112 within the predetermined period. It should be noted that the amount of input data and the amount of output data, which are used by the statistical information calculation unit 121 for calculation, are the number of frames of input data and the number of frames of output data, respectively. Further, the amount of input data and the amount of output data, which are used by the statistical information calculation unit 121 for calculation, may be the number of bytes of input data and the number of bytes of output data, respectively.

When the absolute value of a result of calculation performed by the statistical information calculation unit 121 is equal to or greater than a predetermined threshold, the management information communication unit 122 transmits failure information indicating that degradation of transmission quality has occurred to the network management apparatus 20. Here, the predetermined threshold may be zero frames or zero bytes, or may be a predetermined number of frames other than zero frames or a predetermined number of bytes other than zero bytes. For example, even if unintentional discarding of the main signal has not occurred, the result of calculation obtained by subtracting the total output statistical information from the total input statistical information may become a number other than zero frames or zero bytes depending on the timing of counting the input statistical information and the output statistical information in the communication apparatus 10. By setting the predetermined threshold to a predetermined number of frames other than zero frames or a predetermined number of bytes other than zero bytes, it is possible to determine that no unintentional discarding of the main signal has occurred even if the result of calculation becomes a number other than zero frames or zero bytes due to the timing of counting input statistical information and output statistical information.

The opposite communication apparatuses 11 and 12 have the same configuration and function as those of the communication apparatus 10. That is, like the communication apparatus 10, each of the opposite communication apparatuses 11 and 12 detects that degradation of transmission quality has occurred based on the difference between total input statistical information and total output statistical information within a predetermined period. Further, when the difference between the total input statistical information and the total output statistical information is equal to or greater than a predetermined threshold, the opposite communication apparatuses 11 and 12 transmit failure information indicating that degradation of the transmission quality has occurred to the network management apparatus 20. Note that the predetermined threshold may differ for each of the communication apparatus 10 and the opposite communication apparatuses 11 and 12.

The network management apparatus 20 determines where in the network 30 a failure has occurred based on information about a connection relation among the plurality of communication apparatuses 10, 11, and 12 connected to the network 30 and failure information transmitted from the plurality of communication apparatuses 10, 11, and 12. Specifically, the network management apparatus 20 stores in advance the connection relation among the plurality of communication apparatuses 10, 11, and 12 connected to the network 30. Further, in the connection relation shown in FIG. 2, for example, when the network management apparatus 20 receives failure information from the communication apparatus 10 and the opposite communication apparatus 11, the network management apparatus 20 determines that degradation of transmission quality (unintentional discarding of a main signal) has occurred in a section of the network 30 between the communication apparatus 10 and the opposite communication apparatus 11.

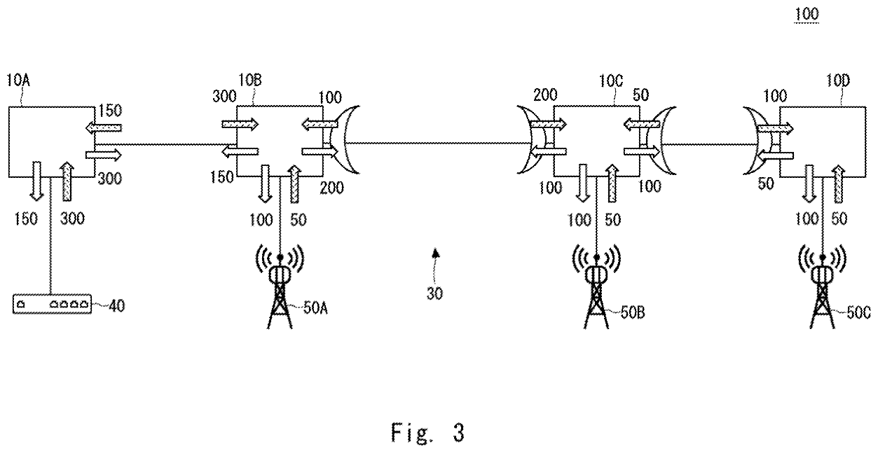

Next, operations of the communication system 100 and the communication apparatus 10 according to the first example embodiment will be described with reference to FIGS. 3 to 6.

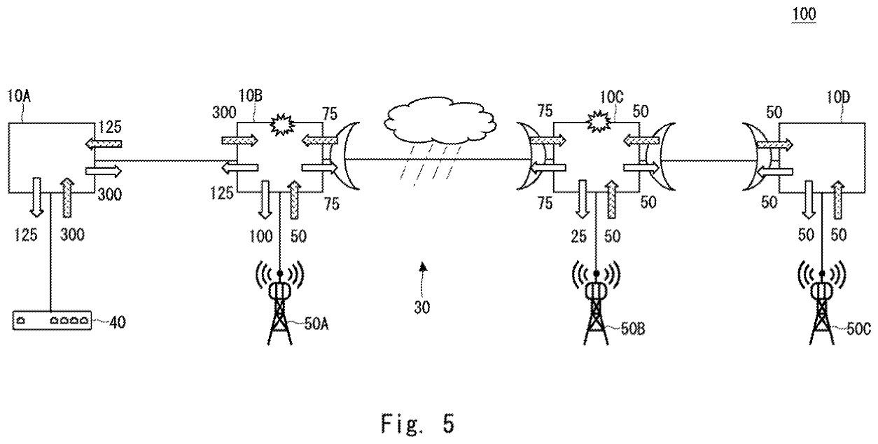

The communication system 100 shown in FIGS. 3 and 5 includes a first communication apparatus 10A, a second communication apparatus 10B, a third communication apparatus 10C, a fourth communication apparatus 10D, a router 40, base stations 50A, 50B, and 50C of mobile telephones, a network management apparatus (not shown), and the network 30. Further, in the communication system 100, each of the first communication apparatus 10A, the second communication apparatus 10B, the third communication apparatus 10C, and the fourth communication apparatus 10D has the same configuration and function as those of the communication apparatus 10. Further, the first communication apparatus 10A, the second communication apparatus 10B, the third communication apparatus 10C, and the fourth communication apparatus 10D, the router 40, and the base stations 50A, 50B, and 50C of mobile telephones are connected to the network 30 so that they can communicate with one another. Specifically, the first communication apparatus 10A is connected to the router 40, and is connected to the second communication apparatus 10B so that they can communicate with each other. Further, the second communication apparatus 10B is connected to the base station 50A of a mobile telephone, the third communication apparatus 10C is connected to the base station 50B of a mobile telephone, and the fourth communication apparatus 10D is connected to the base station 50C of a mobile telephone. Further, the first communication apparatus 10A and the second communication apparatus 10B are connected so that they can communicate by radio, and the second communication apparatus 10B and the third communication apparatus 10C are connected so that they can communicate by radio.

FIG. 3 shows a state in which no unintentional discarding of a main signal has occurred in the network 30. On the other hand, FIG. 5 shows a state in which, in radio communication between the second communication apparatus 10B and the third communication apparatus 10C, the line capacity is reduced due to bad weather or the like and hence unintentional discarding of a main signal has occurred.

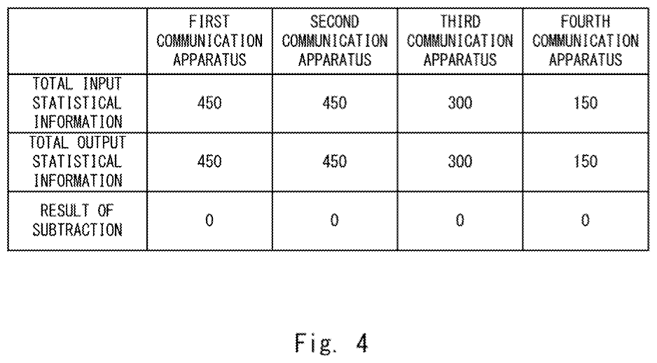

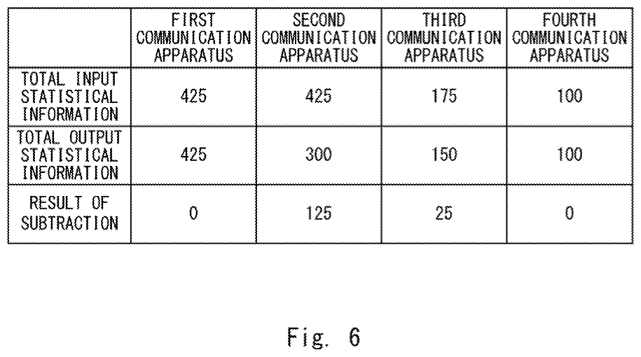

The table in FIG. 4 shows, for each of the communication apparatuses 10A, 10B, 10C, and 10D in the case shown in FIG. 3, total input statistical information, total output statistical information, and a result obtained by subtracting the total output statistical information from the total input statistical information in a predetermined period. Similarly, the table in FIG. 6 shows, for each of the communication apparatuses 10A, 10B, 10C, and 10D in the case shown in FIG. 4, total input statistical information, total output statistical information, and a result obtained by subtracting the total output statistical information from the total input statistical information in a predetermined period.

Further, the numerical values shown in FIGS. 3 to 6 indicate the number of frames of input data and output data of the communication apparatuses 10A, 10B, 10C, and 10D, the router 40, and the base stations 50A, 50B, and 50C of mobile telephones. Further, in FIGS. 3 and 5, outline arrows indicate reception of input data in the communication apparatuses 10A, 10B, 10C, and 10D, and hatched arrows indicate transmission of output data in the communication apparatuses 10A, 10B, 10C, and 10D.

A flow of data transmission in a predetermined period when no degradation of transmission quality (unintentional discarding of a main signal) has occurred in the network 30 will be described below with reference to FIGS. 3 and 4.

A flow of data transmission from the router 40 to each of the base stations 50A, 50B, and 50C of mobile telephones will be first described.

First, the first communication apparatus 10A receives data of 300 frames from the router 40.

Next, the first communication apparatus 10A transmits the data of 300 frames received from the router 40 to the second communication apparatus 10B.

Next, the second communication apparatus 10B receives the data of 300 frames from the first communication apparatus 10A.

Next, the second communication apparatus 10B transmits data of 100 frames from among the data of 300 frames received from the first communication apparatus 10A to the base station 50A of a mobile telephone and transmits the remaining data of 200 frames to the third communication apparatus 10C.

Next, the third communication apparatus 10C receives the data of 200 frames from the second communication apparatus 10B.

Next, the third communication apparatus 10C transmits data of 100 frames from among the data of 200 frames received from the second communication apparatus 10B to the base station 50B of a mobile telephone and transmits the remaining data of 100 frames to the fourth communication apparatus 10D.

Next, the fourth communication apparatus 10D receives the data of 100 frames from the third communication apparatus 10C.

Next, the fourth communication apparatus 10D transmits the data of 100 frames received from the third communication apparatus 10C to the base station 50C of a mobile telephone.

Next, a flow of data transmission from each of the base stations 50A, 50B, and 50C of mobile telephones to the router 40 will be described.

First, the fourth communication apparatus 10D receives data of 50 frames from the base station 50C of a mobile telephone.

Next, the fourth communication apparatus 10D transmits the data of 50 frames received from the base station 50C of a mobile telephone to the third communication apparatus 10C.

Next, the third communication apparatus 10C receives the data of 50 frames from the fourth communication apparatus 10D and receives data of 50 frames from the base station 50B of a mobile telephone.

Next, the third communication apparatus 10C transmits the data of 50 frames received from the fourth communication apparatus 10D and the data of 50 frames received from the base station 50B of a mobile telephone to the second communication apparatus 10B. That is, the third communication apparatus 10C transmits the data of 100 frames in total to the second communication apparatus 10B.

Next, the second communication apparatus 10B receives the data of 100 frames from the third communication apparatus 10C and receives data of 50 frames from the base station 50 A of a mobile telephone.

Next, the second communication apparatus 10B transmits the data of 100 frames received from the third communication apparatus 10C and the data of 50 frames received from the base station 50A of a mobile telephone to the first communication apparatus 10A. That is, the second communication apparatus 10B transmits the data of 150 frames in total to the first communication apparatus 10A.

Next, the first communication apparatus 10A receives the data of 150 frames from the second communication apparatus 10B.

Next, the first communication apparatus 10A transmits the data of 150 frames received from the second communication apparatus 10B to the router 40.

The table in FIG. 4 shows, for each of the communication apparatuses 10A, 10B, 10C, and 10D in the data transmission shown in FIG. 3, total input statistical information, total output statistical information, and a result obtained by subtracting the total output statistical information from the total input statistical information. For example, the second communication apparatus 10B receives data of 300 frames from the first communication apparatus 10A, data of 100 frames from the third communication apparatus 10C, and data of 50 frames from the base station 50A of a mobile telephone in a predetermined period, and accordingly the total input statistical information is 450 frames. Meanwhile, the second communication apparatus 10B transmits data of 100 frames to the base station 50A of a mobile telephone, data of 200 frames to the third communication apparatus 10C, and data of 150 frames to the first communication apparatus 10A in the predetermined period, and accordingly the total output statistical information is 450 frames. Therefore, the result obtained by subtracting the total output statistical information of the second communication apparatus 10B from the total input statistical information of the same in the predetermined period is zero.

As shown in FIG. 4, degradation of transmission quality (unintentional discarding of a main signal) has not occurred in any section of the network 30, and thus the results obtained by subtracting the total output statistical information of the communication apparatuses 10A, 10B, 10C, and 10D from the total input statistical information of the communication apparatuses 10A, 10B, 10C, and 10D, respectively, are all zero.

Next, a flow of data transmission in a predetermined period when degradation of transmission quality (unintentional discarding of a main signal) has occurred in the network 30 will be described with reference to FIGS. 5 and 6. Specifically, in the example shown in FIG. 5, in radio communication between the second communication apparatus 10B and the third communication apparatus 10C, the line capacity is reduced due to bad weather or the like and hence unintentional discarding of a main signal has occurred.

A flow of data transmission from the router 40 to each of the base stations 50A, 50B, and 50C of mobile telephones will be first described.

First, the first communication apparatus 10A receives data of 300 frames from the router 40.

Next, the first communication apparatus 10A transmits the data of 300 frames received from the router 40 to the second communication apparatus 10B.

Next, the second communication apparatus 10B receives the data of 300 frames from the first communication apparatus 10A.

Next, the second communication apparatus 10B transmits data of 100 frames from among the data of 300 frames received from the first communication apparatus 10A to the base station 50A of a mobile telephone. Further, the second communication apparatus 10B attempts to transmit the remaining data of 200 frames to the third communication apparatus 10C. In actuality, however, the second communication apparatus 10B transmits data of only 75 frames to the third communication apparatus 10C, because unintentional discarding of the main signal has occurred in the radio communication between the second communication apparatus 10B and the third communication apparatus 10C.

Next, the third communication apparatus 10C receives the data of 75 frames from the second communication apparatus 10B.

Next, the third communication apparatus 10C transmits data of 25 frames from among the data of 75 frames received from the second communication apparatus 10B to the base station 50B of a mobile telephone and transmits the remaining data of 50 frames to the fourth communication apparatus 10D.

Next, the fourth communication apparatus 10D receives the data of 50 frames from the third communication apparatus 10C.

Next, the fourth communication apparatus 10D transmits the data of 50 frames received from the third communication apparatus 10C to the base station 50C of a mobile telephone.

Next, a flow of data transmission from each of the base stations 50A, 50B, and 50C of mobile telephones to the router 40 will be described.

First, the fourth communication apparatus 10D receives data of 50 frames from the base station 50C of a mobile telephone.

Next, the fourth communication apparatus 10D transmits the data of 50 frames received from the base station 50C of a mobile telephone to the third communication apparatus 10C.

Next, the third communication apparatus 10C receives the data of 50 frames from the fourth communication apparatus 10D and receives data of 25 frames from the base station 50B of a mobile telephone.

Next, the third communication apparatus 10C transmits the data of 50 frames received from the fourth communication apparatus 10D and the data of 25 frames received from the base station 50B of a mobile telephone to the second communication apparatus 10B. That is, the third communication apparatus 10C transmits the data of 75 frames in total to the second communication apparatus 10B. Note that unintentional discarding of the main signal has occurred in the radio communication between the second communication apparatus 10B and the third communication apparatus 10C, but in this example, it is possible to transmit up to 75 frames even when the transmission quality thereof has been degraded.

Next, the second communication apparatus 10B receives the data of 75 frames from the third communication apparatus 10C and receives data of 50 frames from the base station 50A of a mobile telephone.

Next, the second communication apparatus 10B transmits the data of 75 frames received from the third communication apparatus 10C and the data of 50 frames received from the base station 50A of a mobile telephone to the first communication apparatus 10A. That is, the second communication apparatus 10B transmits the data of 125 frames in total to the first communication apparatus 10A.

Next, the first communication apparatus 10A receives the data of 125 frames from the second communication apparatus 10B.

Next, the first communication apparatus 10A transmits the data of 125 frames received from the second communication apparatus 10B to the router 40.

The table in FIG. 6 shows, for each of the communication apparatuses 10A, 10B, 10C, and 10D in the data transmission shown in FIG. 5, total input statistical information, total output statistical information, and a result obtained by subtracting the total output statistical information from the total input statistical information. For example, the second communication apparatus 10B receives data of 300 frames from the first communication apparatus 10A, data of 75 frames from the third communication apparatus 10C, and data of 50 frames from the base station 50A of a mobile telephone in a predetermined period, and accordingly the total input statistical information becomes 425 frames. Meanwhile, the second communication apparatus 10B transmits data of 100 frames to the base station 50A of a mobile telephone, data of 75 frames to the third communication apparatus 10C, and data of 125 frames to the first communication apparatus 10A in the predetermined period, and accordingly the total output statistical information becomes 300 frames. Therefore, the result obtained by subtracting the total output statistical information of the second communication apparatus 10B from the total input statistical information of the same in the predetermined period is 125.

As shown in FIG. 6, degradation of transmission quality (unintentional discarding of a main signal) has occurred in the radio communication between the second communication apparatus 10B and the third communication apparatus 10C, and thus the results obtained by subtracting the total output statistical information of the second communication apparatus 10B and the third communication apparatus 10C from the total input statistical information of the second communication apparatus 10B and the third communication apparatus 10C, respectively, are not zero.

As described above, in each of the communication apparatuses 10A, 10B, 10C, and 10D, by subtracting the total output statistical information, which is the total amount of output data that is output within a predetermined period, from the total input statistical information, which is the total amount of input data that is input within the predetermined period, it is possible to detect that degradation of transmission quality (unintentional discarding of a main signal) has occurred in the network 30.

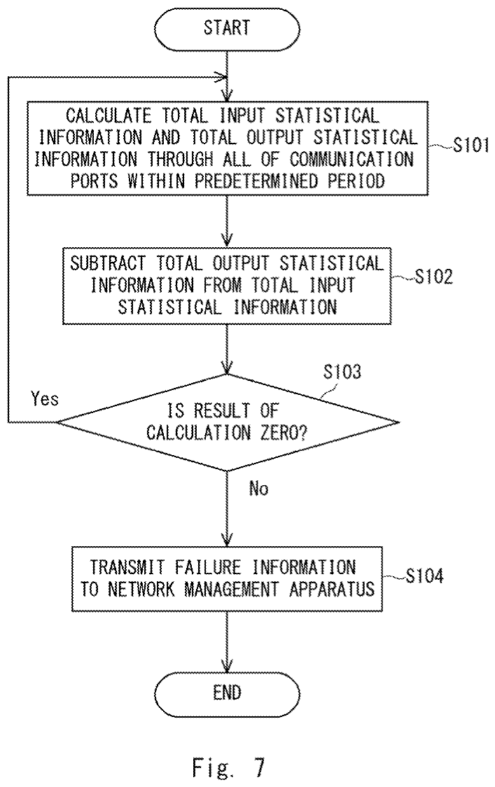

Next, a communication method according to the first example embodiment will be described with reference to a flowchart shown in FIG. 7.

First, the statistical information calculation unit 121 adds up the amount of input data that is input through all of the communication ports 111 and 112 within a predetermined period, thereby calculating the total input statistical information, and adds up the amount of output data that is output through all of the communication ports 111 and 112 within the predetermined period, thereby calculating the total output statistical information (Step S101). Specifically, the statistical information calculation unit 121 adds up input statistical information acquired from the statistical information acquisition unit 113 and inputs statistical information acquired from the statistical information acquisition unit 114, thereby calculating the total input statistical information which is the total amount of input data that is input through all of the communication ports 111 and 112 within the predetermined period. Further, the statistical information calculation unit 121 adds up output statistical information acquired from the statistical information acquisition unit 113 and output statistical information acquired from the statistical information acquisition unit 114, thereby calculating the total output statistical information which is the total amount of output data that is output through all of the communication ports 111 and 112 within the predetermined period.

Next, the statistical information calculation unit 121 subtracts the total output statistical information from the total input statistical information (Step S102).

Next, the management information communication unit 122 determines whether or not the result of calculation performed in Step S102 is zero (Step S103).

In Step S103, if the result of calculation performed in Step S102 is zero (Yes in Step S103), the process returns to Step S101.

In Step S103, if the result of calculation performed in Step S102 is not zero (No in Step S103), the management information communication unit 122 transmits failure information indicating that degradation of transmission quality (unintentional discarding of a main signal) has occurred to the network management apparatus 20 (Step S104).

By the above-described communication system 100, communication apparatus 10, and communication method according to the first example embodiment of the present disclosure, it is possible to detect degradation of transmission quality based on whether or not the difference between the total input statistical information and the total output statistical information within a predetermined period is equal to or greater than a predetermined threshold. That is, when unintentional discarding of a main signal has occurred due to degradation of transmission quality and hence the total amount of output data that is output through the communication ports 111 and 112 relative to the total amount of input data that is input through the communication ports 111 and 112 is reduced, it is possible to detect degradation of the transmission quality. Then, it is possible to send failure information indicating that degradation of the transmission quality has occurred to the network management apparatus 20.

Further, the communication apparatus 10 transmits only the failure information indicating that degradation of the transmission quality has occurred to the network management apparatus 20. This configuration eliminates the possibility of narrowing the communication band for transmitting and receiving the main signal.

Further, since input data and output data in all of the plurality of communication ports 111 and 112 are collectively managed, it is possible to make the hardware configuration of the communication apparatus 10 simple as compared with the case in which input data and output data are managed for each of the plurality of communication ports 111 and 112. Thus, it is possible to reduce the cost for the communication apparatus 10. Therefore, it is possible to easily detect degradation of transmission quality while keeping costs low.

Further, the amount of input data and the amount of output data, which are used by the statistical information calculation unit 121 for calculation, may be the number of bytes of input data and the number of bytes of output data, respectively. Therefore, it is possible to apply the communication method according to the present disclosure, for example, to a case in which the communication apparatus 10 divides a frame having a predetermined length or longer or integrates a plurality of frames having a predetermined length or shorter and then distributes main signals.

Further, the predetermined threshold value, which serves as a reference for the management information communication unit 122 to determine whether or not degradation of transmission quality has occurred, may be a predetermined number of frames other than zero frames or a predetermined number of bytes other than zero bytes. By such a configuration, when, for example, no unintentional discarding of a main signal has occurred but the absolute value of the result of calculation obtained by subtracting the total output statistical information from the total input statistical information becomes a number other than zero frames or zero bytes due to the timing of counting the input statistical information and the output statistical information in the communication apparatus 10, it is possible to accurately determine that no degradation of transmission quality has occurred.

Further, the network management apparatus 20 stores in advance a connection relation among the plurality of communication apparatuses 10, 11, and 12 connected to the network 30. Therefore, the network management apparatus 20 can determine where in the network 30 a failure has occurred based on information about the connection relation and failure information transmitted from the plurality of communication apparatuses 10, 11, and 12.

Although the present disclosure has been described as a hardware configuration in the above-described example embodiment, the present disclosure is not limited thereto. In the present disclosure, the processing steps shown in the flowchart of FIG. 7 can be implemented by causing a Central Processing Unit (CPU) to execute a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiment and may be modified as appropriate without departing from the spirit of the present disclosure. For example, transmission of failure information from the communication apparatus 10 to the network management apparatus 20 may be performed periodically while the failure is occurring. Further, the failure information may be transmitted only once, and when the failure is eliminated, recovery information indicating that the failure is eliminated may be transmitted from the communication apparatus 10 to the network management apparatus 20.

According to the present disclosure, it is possible to provide a communication apparatus, a communication system, a communication method, and a non-transitory computer readable medium storing a communication program that are capable of easily detecting degradation of transmission quality while keeping costs low.

What is claimed is:

1. A communication apparatus comprising:
a statistical information calculation unit configured to subtract total output statistical information from total input statistical information, the total output statistical information being a total amount of output data that is output through a communication port within a predetermined period, the total input statistical information being a total amount of input data that is input through the communication port within the predetermined period; and
a management information communication unit configured to transmit failure information indicating that degradation of transmission quality has occurred to a network management apparatus when an absolute value of a result of the calculation performed by the statistical information calculation unit is equal to or greater than a predetermined threshold.

2. The communication apparatus according to claim 1, wherein an amount of the input data and an amount of the output data, respectively, are the number of bytes of the input data and the number of bytes of the output data, the amount of the input data and the amount of the output data being used by the statistical information calculation unit for the calculation.

3. A communication system comprising: a plurality of communication apparatuses connected to one another through a network so that they can communicate with one another; and a network management apparatus configured to manage the communication performed by the plurality of communication apparatuses through the network,
wherein the communication apparatus comprises:
a statistical information calculation unit configured to subtract total output statistical information from total input statistical information, the total output statistical information being a total amount of output data that is output through a communication port within a predetermined period, the total input statistical information being a total amount of input data that is input through the communication port within the predetermined period; and
a management information communication unit configured to transmit failure information indicating that degradation of transmission quality has occurred to the network management apparatus when an absolute value of a result of the calculation performed by the statistical information calculation unit is equal to or greater than a predetermined threshold.

4. The communication system according to claim 3, wherein the network management apparatus determines where in the network a failure has occurred based on information about a connection relation among the plurality of communication apparatuses and the failure information transmitted from the plurality of communication apparatuses.

5. The communication system according to claim 3, wherein an amount of the input data and an amount of the output data, respectively, are the number of bytes of the input data and the number of bytes of the output data, the amount of the input data and the amount of the output data being used by the statistical information calculation unit for the calculation.

6. A communication method performed by a communication apparatus, comprising:
subtracting total output statistical information from total input statistical information, the total output statistical information being a total amount of output data that is output through a communication port within a predetermined period, the total input statistical information being a total amount of input data that is input through the communication port within the predetermined period; and
transmitting failure information indicating that degradation of transmission quality has occurred to a network management apparatus when an absolute value of a result of the calculation obtained by subtracting the total output statistical information from the total input statistical information is equal to or greater than a predetermined threshold.

7. The communication method according to claim 6, wherein an amount of the input data and an amount of the output data, respectively, are the number of bytes of the input data and the number of bytes of the output data, the amount of the input data and the amount of the output data being used by the communication apparatus for the calculation.
